(19) United States
(12) Patent Application Publication
(10) Pub. No.: US 2026/0083625 A1
(43) Pub. Date: Mar. 26, 2026

(54) TRANSMISSION DEVICE OF MASSAGE CHAIR

(71) Applicant: Shanghai Rongtai Health Technology Corporation Limited, Shanghai (CN)

(72) Inventor: Dong-Her Wu, Chang Hua Hsien (TW)

(21) Appl. No.: 19/184,698

(22) Filed: Apr. 21, 2025

(30) Foreign Application Priority Data
Sep. 20, 2024 (TW) 113135860

(51) Int. Cl. A61H 15/00

(52) U.S. Cl. CPC A61H 15/0078; A61H 2015/0035; A61H 2201/0142; A61H 2201/0149; A61H 2201/0165; A61H 2201/1215; A61H 2201/14; A61H 2201/1669

(57) ABSTRACT

A transmission device of a massage chair contains: a base and a massager. The base includes a frame, two first ropes, and two second ropes. The massager includes a first rotary shaft and a second rotary shaft, the first rotary shaft includes two first rotatable wheels, and a respective one first rotatable wheel has a first threaded section and is rolled on the first threaded section of the respective one first rotatable wheel. The second rotary shaft includes two second rotatable wheels, and a respective one second rotatable wheel has a second threaded section and is rolled on the second threaded section of the respective one second rotatable wheel. The massager includes a motor configured to drive the first rotary shaft or the second rotary shaft, a drive wheel is meshed with the respective one first rotatable wheel and the respective one second rotatable wheel.

### TECHNICAL FIELD

The present invention relates a transmission device of a massage chair by which the massager moves forward and backward reciprocately along an inner wall of the frame to massage user matingly with even massaging force.

### BACKGROUND

The back of the human body is where the main muscles and bones of the spine are located. Compared with the limbs, the spine is more difficult to move, so it is common to purchase massage equipment to massage the back. Although a large number of massage mechanisms can be arranged to massage the entire back, this will lead to a complicated structure and will also increase weight and cost. Therefore, it should be simpler and more cost-effective to make a single massage mechanism move back and forth to massage the entire back.

In addition, the reciprocating movement of the massage mechanism must take into account the shape of each user's back. If the massage mechanism cannot fit the human body, there will be uneven force, which can easily cause discomfort.

The massage assembly of the conventional transmission massage machine has a driver composed of a reducer and a motor, and a transmission shaft extending to both sides is passed through the driver. However, the driver has only the center as a fulcrum, and the driver has the problem of shaking left and right and up and down, which is unstable and makes it impossible to move long distances. In addition, the first and second reel belts are also skewed and loose, which affects the massage.

The present invention has arisen to mitigate and/or obviate the afore-described disadvantages.

### SUMMARY

The primary aspect of the present invention is to provide a transmission device of a massage chair by which the massager moves forward and backward reciprocately along an inner wall of the frame to massage user matingly with even massaging force.

To obtain above-mentioned aspect, a transmission device of a massage chair provided by the present invention contains: a base and a massager.

The base includes a frame, two first ropes connected on two sides of a front end of the frame, and two second ropes connected on two sides of a rear end of the frame. The two first ropes and the two second ropes are a steel cable.

The massager includes a first rotary shaft and a second rotary shaft which are rotatably connected on a front end and a rear end of the massager, the first rotary shaft includes two first rotatable wheels connected on two sides thereof, and a respective one first rotatable wheel has a first threaded section formed thereon, the respective one first rope is rolled on the first threaded section of the respective one first rotatable wheel. The second rotary shaft includes two second rotatable wheels connected on two sides thereof, and a respective one second rotatable wheel has a second threaded section formed thereon, and the respective one second rope is rolled on the second threaded section of the respective one second rotatable wheel.

The massager includes a motor configured to drive the first rotary shaft or the second rotary shaft, a drive wheel is meshed with the respective one first rotatable wheel and the respective one second rotatable wheel so as to drive the respective one first rotatable wheel and the respective one second rotatable wheel to rotate in a same direction. The respective one first rotatable wheel is configured to roll the first rope, and the respective one second rotatable wheel is configured to unroll the second rope. Alternatively, the respective one first rotatable wheel is configured to unroll the first rope, and the respective one second rotatable wheel is configured to roll the second rope, such that the massager moves forward and backward reciprocately along an inner wall of the frame, and the massager includes a massage element configured to massage a user sit on the base.

In operation, the drive wheel actuates the first respective one first rotatable wheel and the respective one second rotatable wheel to rotate, and the first threaded section of the respective one first rotatable wheel and the second threaded section of the respective one second rotatable wheel roll or unroll the first rope and the second rope, and the massager moves forward and backward reciprocately along the frame to massage the user. Also, the respective one first rope and the respective one second rope stretch or retract so that the massager massages the user matingly, thus enhancing massaging comfort. Preferably, the respective one first rope and the respective one second rope are the steel cable to enhance safety coefficient and using reinforcement.

### BRIEF DESCRIPTION OF THE DRAWINGS

FIG. 1 is a perspective view showing the assembly of a transmission device of a massage chair according to a preferred embodiment of the present invention.

FIG. 2 is a perspective view showing the exploded components of the transmission device of the massage chair according to the preferred embodiment of the present invention.

FIG. 3 is a side plan view showing the assembly of the transmission device of the massage chair according to the preferred embodiment of the present invention.

FIG. 4 is a cross sectional view showing the assembly of the transmission device of the massage chair according to the preferred embodiment of the present invention.

FIG. 5 is a cross sectional view showing the operation of the transmission device of the massage chair according to the preferred embodiment of the present invention.

FIG. 6 is another cross sectional view showing the operation of the transmission device of the massage chair according to the preferred embodiment of the present invention.

FIG. 7 is another side plan view showing the assembly of the transmission device of the massage chair according to the preferred embodiment of the present invention.

FIG. 8 is also another cross sectional view showing the operation of the transmission device of the massage chair according to the preferred embodiment of the present invention.

FIG. 9 is a side plan view showing the application of the transmission device of the massage chair according to the preferred embodiment of the present invention.

FIG. 10 is another side plan view showing the application of the transmission device of the massage chair according to the preferred embodiment of the present invention.

FIG. 11 is a perspective view showing the application of the transmission device of the massage chair according to the preferred embodiment of the present invention.

FIG. 12 is a perspective view showing the exploded components of a part of the transmission device of the massage chair according to the preferred embodiment of the present invention.

FIG. 13 is a side plan view showing the assembly of a part of the transmission device of the massage chair according to the preferred embodiment of the present invention.

### DETAILED DESCRIPTION

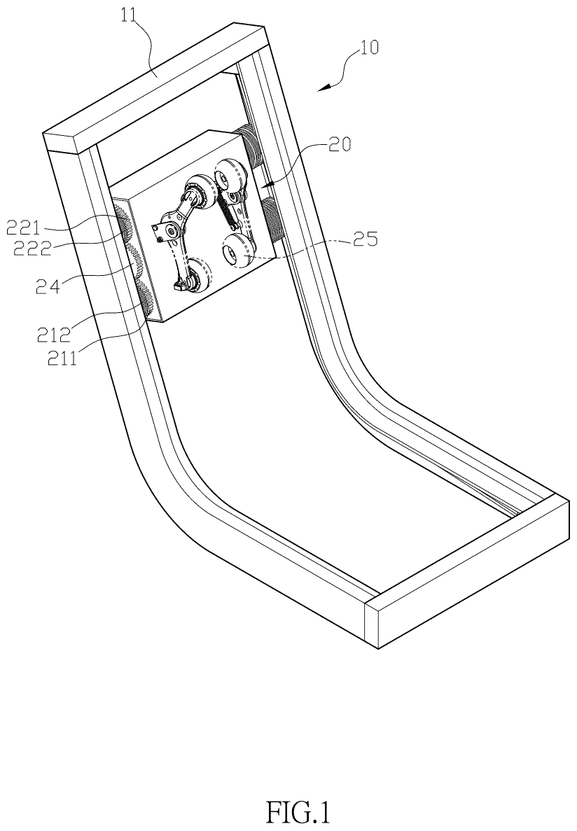

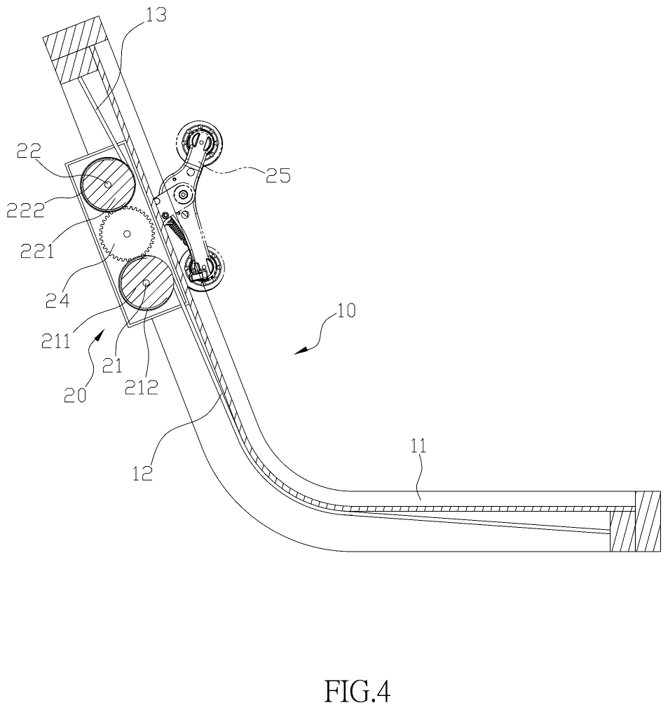

With reference to FIGS. 1-4, a transmission device of a massage chair according to a preferred embodiment of the present invention comprises: a base 10 and a massager 20, wherein the base 10 includes a frame 11, two first ropes 12 connected on two sides of a front end of the frame 11, and two second ropes 13 connected on two sides of a rear end of the frame 11, wherein the two first ropes 12 and the two second ropes 13 are a steel cable.

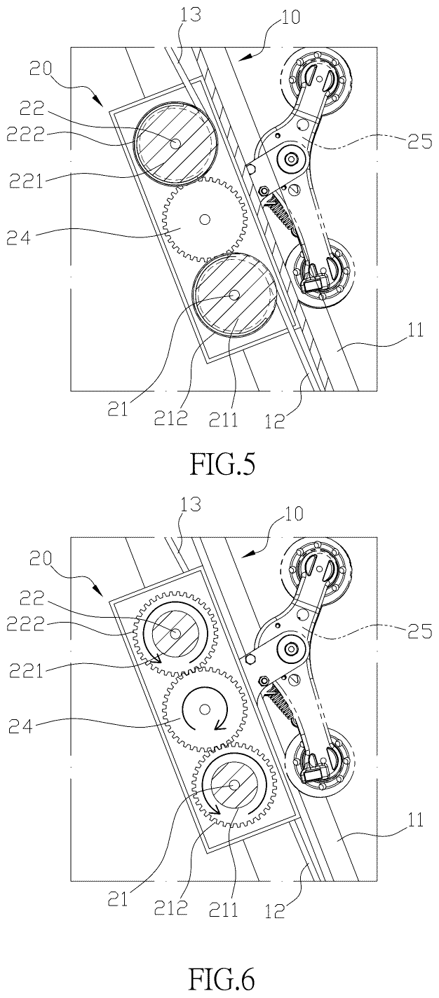

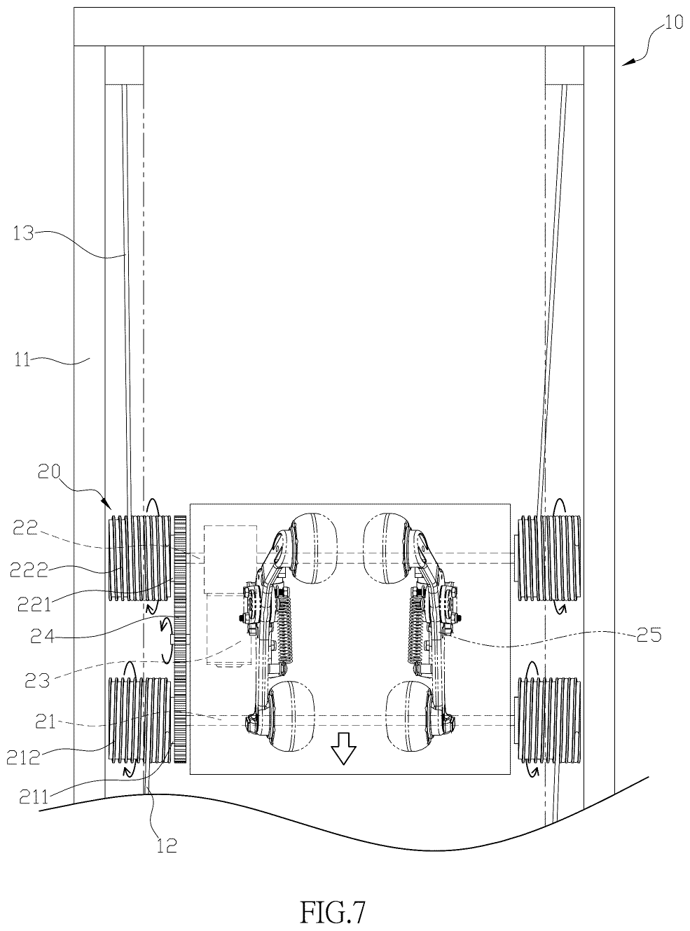

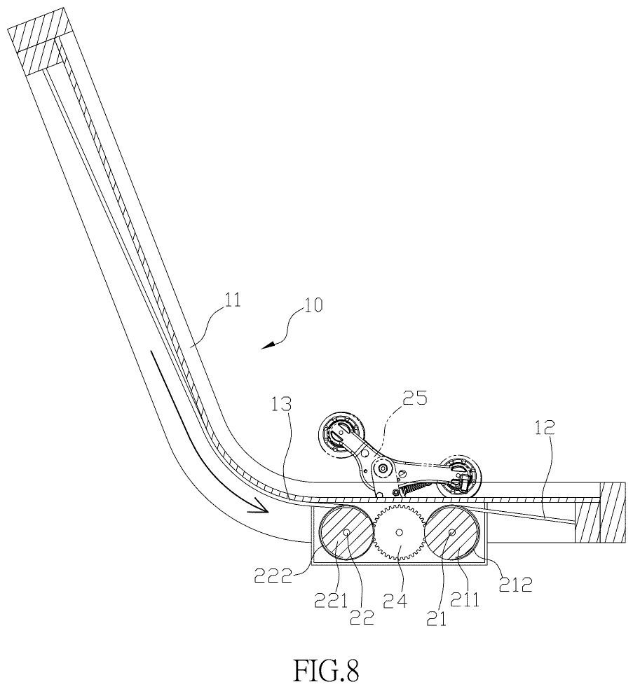

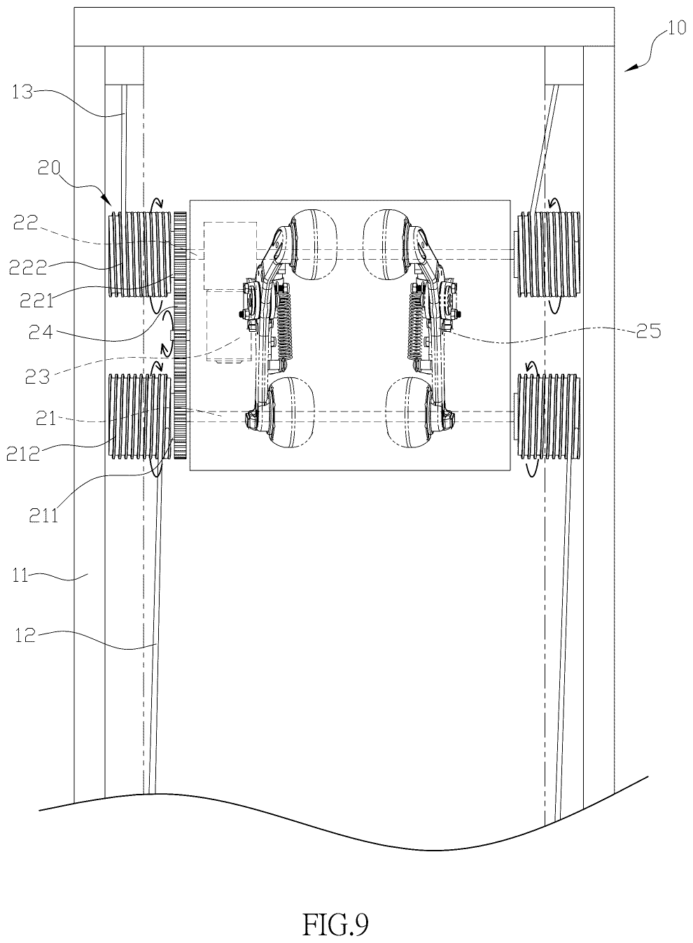

The massager 20 includes a first rotary shaft 21 and a second rotary shaft 22 which are rotatably connected on a front end and a rear end of the massager 20, wherein the first rotary shaft 21 includes two first rotatable wheels 211 connected on two sides thereof, and a respective one first rotatable wheel 211 has a first threaded section 212 formed thereon, the respective one first rope 12 is rolled on the first threaded section 212 of the respective one first rotatable wheel 211, wherein the second rotary shaft 22 includes two second rotatable wheels 221 connected on two sides thereof, and a respective one second rotatable wheel 221 has a second threaded section 222 formed thereon, and the respective one second rope 13 is rolled on the second threaded section 222 of the respective one second rotatable wheel 221. The massager 20 includes a motor 23 configured to drive the first rotary shaft 21 or the second rotary shaft 22 to rotate, as shown in FIGS. 5 and 6, a drive wheel 24 is meshed with the respective one first rotatable wheel 211 and the respective one second rotatable wheel 221 so as to drive the respective one first rotatable wheel 211 and the respective one second rotatable wheel 221 to rotate in a same direction. Referring to FIGS. 7-9, the respective one first rotatable wheel 211 is configured to roll the first rope 12, and the respective one second rotatable wheel 221 is configured to unroll the second rope 13. Alternatively, the respective one first rotatable wheel 211 is configured to unroll the first rope 12, and the respective one second rotatable wheel 221 is configured to roll the second rope 13, such that the massager 20 moves forward and backward reciprocately along an inner wall of the frame 11, and the massager 20 includes a massage element 25 configured to massage a user sit on the base 10.

As shown in FIGS. 6-8, in operation, the drive wheel 24 actuates the first respective one first rotatable wheel 211 and the respective one second rotatable wheel 221 to rotate, and the first threaded section 212 of the respective one first rotatable wheel 211 and the second threaded section 222 of the respective one second rotatable wheel roll or unroll the first rope 12 and the second rope 13, and the massager 20 moves forward and backward reciprocately along the frame 11 to massage the user. Also, the respective one first rope 12 and the respective one second rope 13 stretch or retract so that the massager 20 massages the user matingly, thus enhancing massaging comfort. Preferably, the respective one first rope 12 and the respective one second rope 13 are the steel cable to enhance safety coefficient and using reinforcement.

The massager 20 moves forward and backward reciprocately along the inner wall of the frame 11 based on a length and a using angle of the frame 11 to obtain different massaging ranges. For example, the length of the frame 11 is long enough to massage a back, buttocks, and calves of the user. Also, the massager 25 massages users with various figures by using the respective one first rope 12 and the respective one second rope 13.

The first rotary shaft 21 and the second rotary shaft 22 balance the front end and the rear end of the massager 20 to prevent a vibration of the massager 20 and to enhance a moving length of the massager 20.

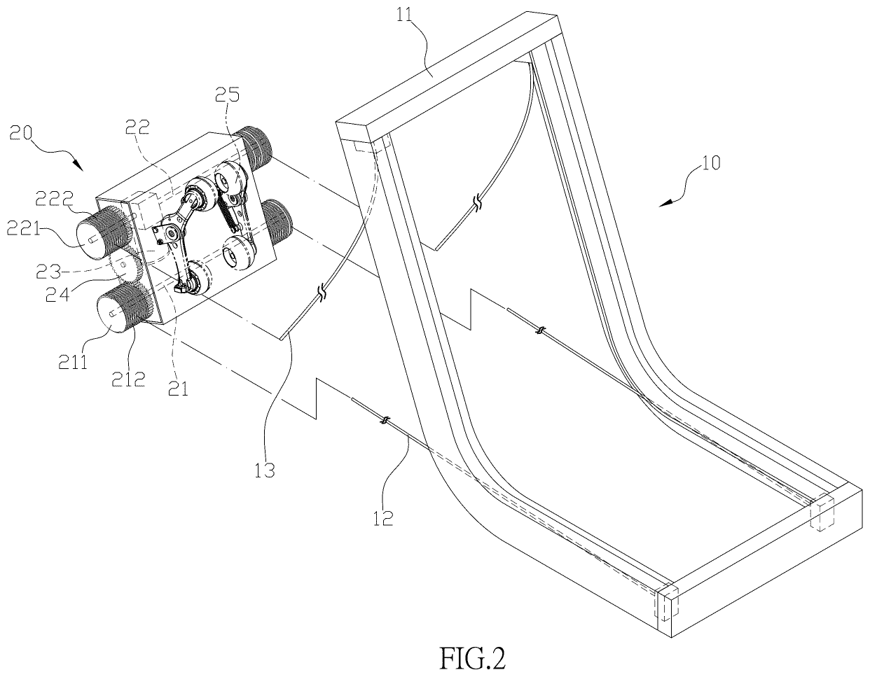

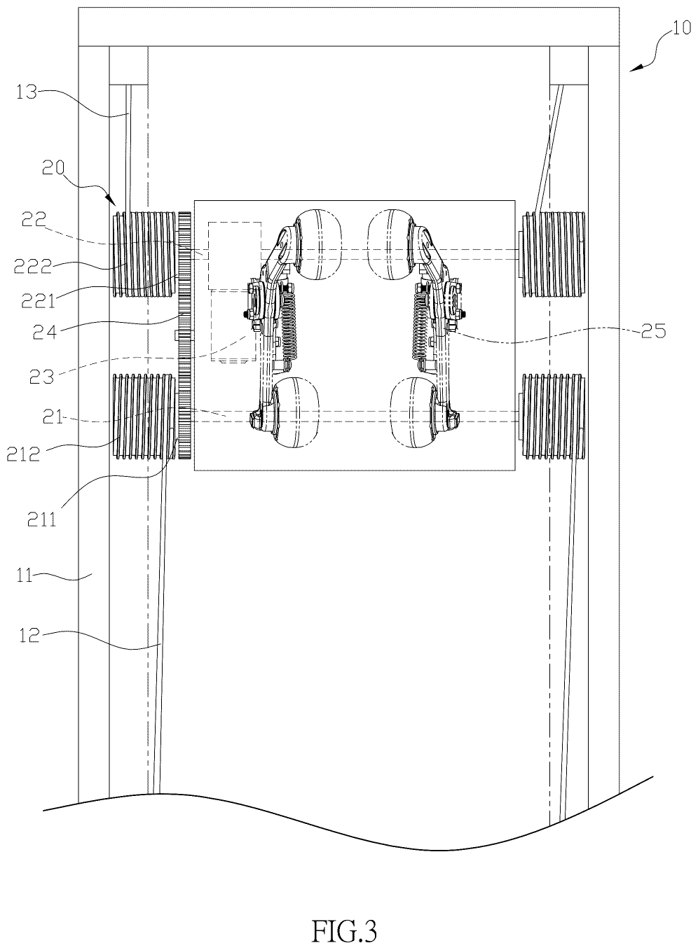

As illustrated in FIGS. 2-3, in another embodiment, the drive wheel 24, the first rotary shaft 211 and the second rotary shaft 221 are located on a left side of the massager 20.

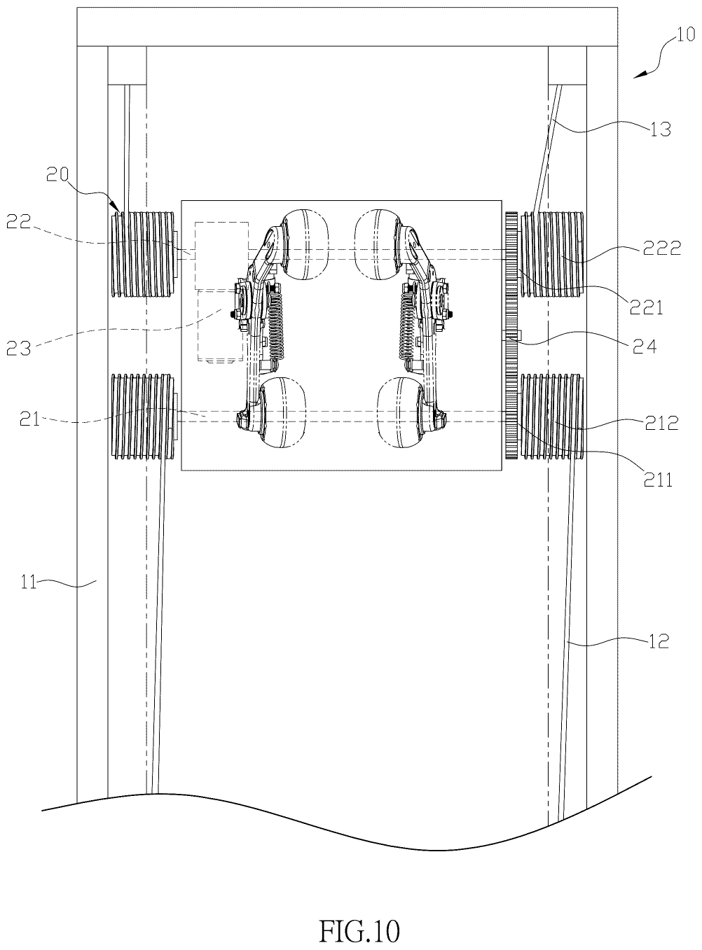

With reference to FIG. 10, in another embodiment, the drive wheel 24, the first rotary shaft 211 and the second rotary shaft 221 are located on a right side of the massager 20.

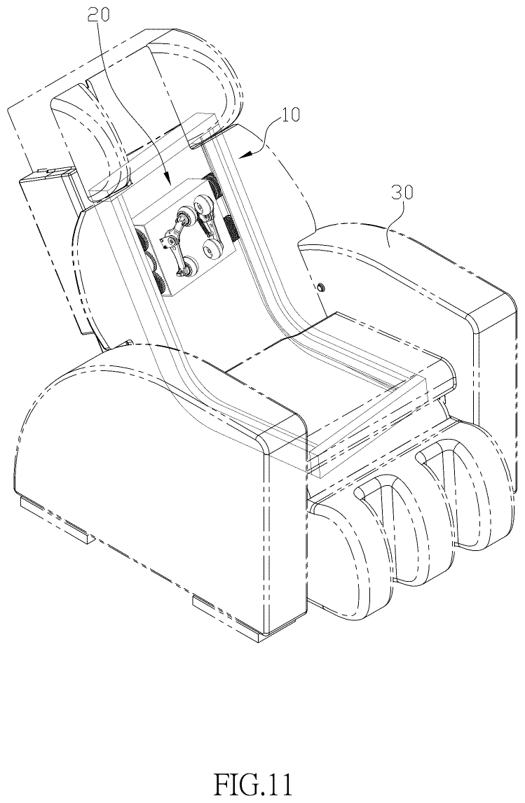

Referring to FIG. 11, in another embodiment, the base 10 and the massager 20 are mounted in the massage chair 30.

In another embodiment, the base 10 and the massager 20 are mounted in a massage bed (not shown).

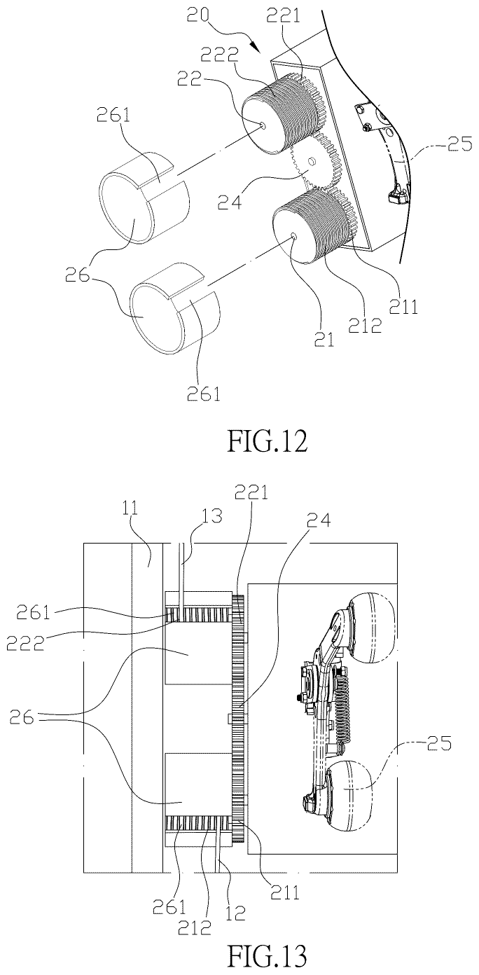

As shown in FIGS. 12 and 13, the first threaded section 212 and the second threaded section 222 are covered by two protective sleeves 26 respectively, wherein a respective one protective sleeve 26 includes a limiting trench 261 configured to accommodate the respective one first rope 12 or the respective one second rope 13 so that the respective one fist rope 12 and the respective one second rope 13 are rolled or unrolled along the first threaded section 212 and the second threaded section 222 respectively.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A transmission device of a massage chair comprising: a base and a massager;
wherein the base includes a frame, two first ropes connected on two sides of a front end of the frame, and two second ropes connected on two sides of a rear end of the frame, wherein the two first ropes and the two second ropes are a steel cable;
wherein the massager includes a first rotary shaft and a second rotary shaft which are rotatably connected on a front end and a rear end of the massager, the first rotary shaft includes two first rotatable wheels connected on two sides thereof, and a respective one first rotatable wheel has a first threaded section formed thereon, the respective one first rope is rolled on the first threaded section of the respective one first rotatable wheel, wherein the second rotary shaft includes two second rotatable wheels connected on two sides thereof, and a respective one second rotatable wheel has a second threaded section formed thereon, and the respective one second rope is rolled on the second threaded section of the respective one second rotatable wheel;
wherein the massager includes a motor configured to drive the first rotary shaft or the second rotary shaft, a drive wheel is meshed with the respective one first rotatable wheel and the respective one second rotatable wheel so as to drive the respective one first rotatable wheel and the respective one second rotatable wheel to rotate in a same direction, wherein the respective one first rotatable wheel is configured to roll the first rope, and the respective one second rotatable wheel is configured to unroll the second rope, alternatively, the respective one first rotatable wheel is configured to unroll the first rope, and the respective one second rotatable wheel is configured to roll the second rope, such that the massager moves forward and backward reciprocately along an inner wall of the frame, and the massager includes a massage element configured to massage a user sit on the base.

2. The transmission device of the massage chair as claimed in claim 1, wherein the drive wheel, the first rotary shaft and the second rotary shaft are located on a left side of the massager.

3. The transmission device of the massage chair as claimed in claim 1, wherein the drive wheel, the first rotary shaft and the second rotary shaft are located on a right side of the massager.

4. The transmission device of the massage chair as claimed in claim 1, wherein the base and the massager are mounted in the massage chair.

5. The transmission device of the massage chair as claimed in claim 1, wherein the base and the massager are mounted in a massage bed.

6. The transmission device of the massage chair as claimed in claim 1, wherein the first threaded section and the second threaded section are covered by two protective sleeves respectively, wherein a respective one protective sleeve includes a limiting trench configured to accommodate the respective one first rope or the respective one second rope.
